(19) United States
(12) Patent Application Publication
(10) Pub. No.: US 2025/0292030 A1
(43) Pub. Date: Sep. 18, 2025

(54) METHOD FOR DEPLOYING AND UPDATING AN ORGANIZATIONAL KNOWLEDGE GRAPH

(71) Applicant: Skale Education Inc. (d.b.a. Upduo), San Francisco, CA (US)

(72) Inventors: Benjamin Min-Jia Chang, San Francisco, CA (US); Wei-Yang Sun, San Francisco, CA (US); Daniel Douglas Eloff, Vancouver (CA); Quinn Hagstrom Freedman, Bellingham, CA (US)

(21) Appl. No.: 19/172,534

(22) Filed: Apr. 7, 2025

Related U.S. Application Data
(63) Continuation-in-part of application No. 18/674,157, filed on May 24, 2024.
(60) Provisional application No. 63/468,874, filed on May 25, 2023.
(60) Provisional application No. 63/575,489, filed on Apr. 5, 2024.

(51) Int. Cl. G06F 40/35; G06N 5/022

(52) U.S. Cl. CPC G06F 40/35; G06N 5/022

(57) ABSTRACT

A method includes: accessing a position of a user in an organization; based on the position, identifying a learning path in a knowledge graph for the user, the learning path including a set of connected nodes within the knowledge graph; retrieving a topic linked to the node in the learning path; prompting the user and a second user to discuss the topic during a guided conversation; based a the transcript of the guided conversation, extracting a captured insight discussed by the user and the second user during the guided conversation; accessing a stored insight linked to the node; calculating a similarity score between the stored insight and the captured insight; calculating a contradiction score between the stored insight and the captured insight; and, if the similarity score exceeds a similarity threshold and the contradiction score falls below a contradiction threshold, confirming correspondence between the captured insight and the stored insight.

### CROSS-REFERENCE TO RELATED APPLICATIONS

This Application is a continuation-in-part application of U.S. patent application Ser. No. 18/674,157, filed on 24 May 2024, which claims the benefit of U.S. Provisional Application No. 63/468,874, filed on 25 May 2023, each of which is incorporated in its entirety by this reference.

This application claims the benefit of U.S. Provisional Application No. 63/575,489, filed on 5 Apr. 2024, which is incorporated in its entirety by this reference.

### TECHNICAL FIELD

This invention relates generally to the field of educational systems and, more specifically, to a new and useful method for deploying and updating an organizational knowledge graph in the field of educational systems.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method; and

FIG. 4 is a flowchart representation of one variation of the method.

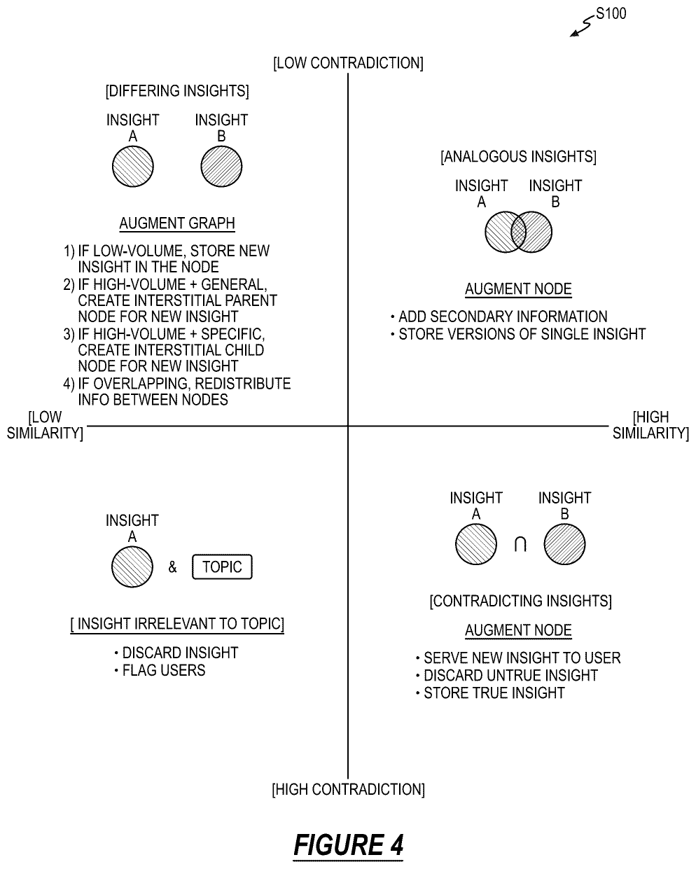

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

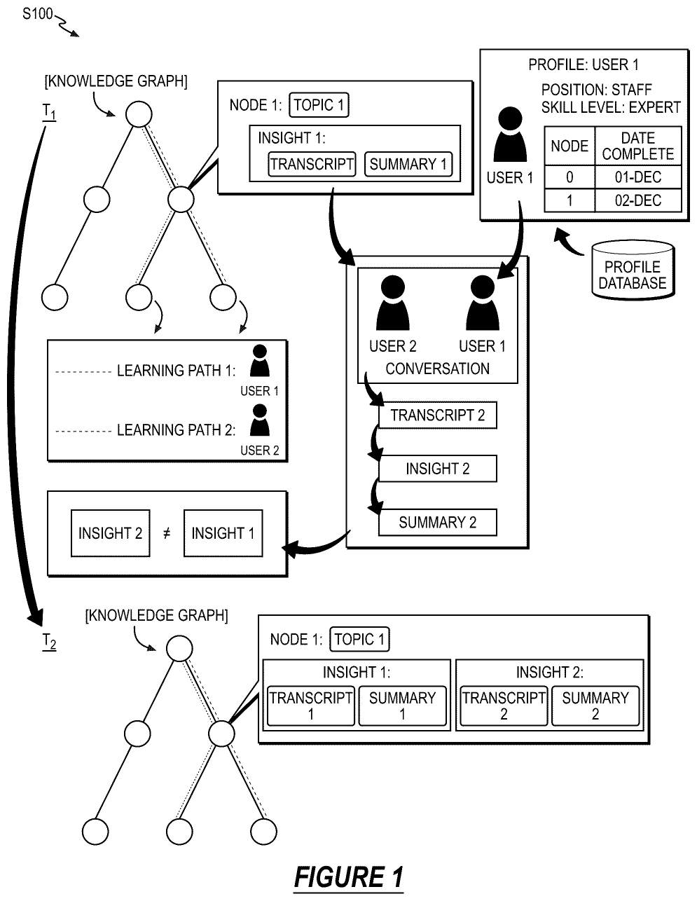

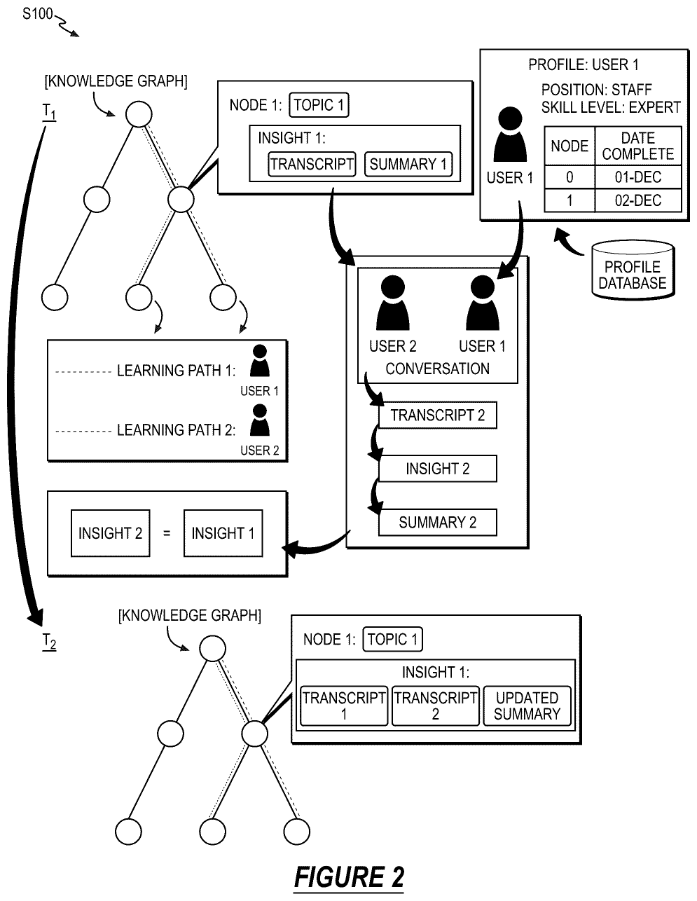

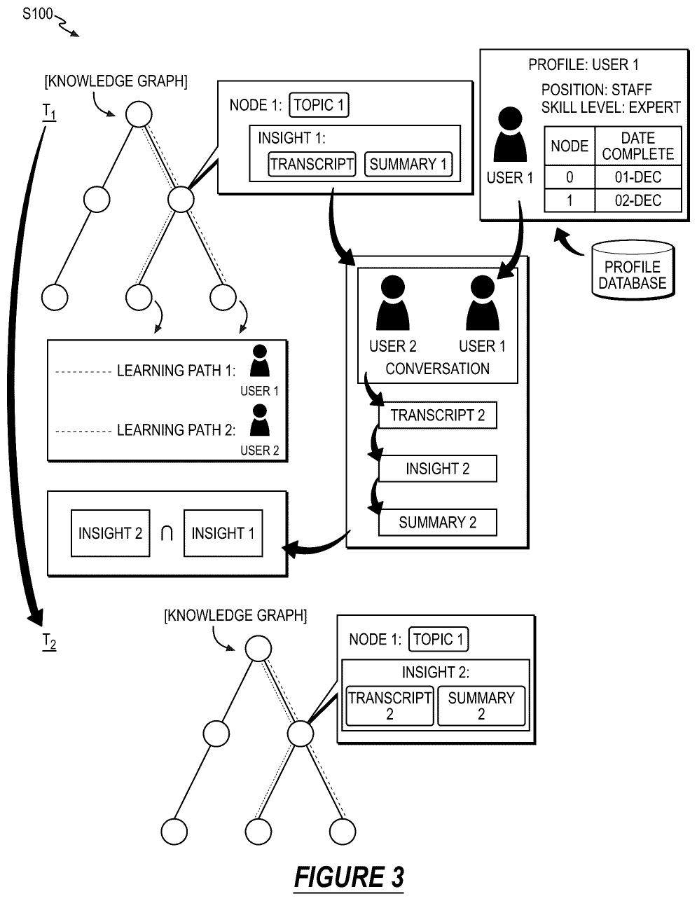

As shown in FIGS. 1-3, a method S100 includes: accessing a position of a first user in an organization; based on the position, identifying a learning path in a knowledge graph for the first user, the learning path including a set of connected nodes within the knowledge graph; retrieving a topic linked to the first node in the learning path; prompting the first user and the second user to discuss the topic during a guided conversation; generating a transcript of the guided conversation; based on the transcript, extracting a captured insight discussed by the first user and the second user during the guided conversation; accessing a stored insight linked to the first node; calculating a similarity score between the stored insight and the captured insight; and calculating a contradiction score between the stored insight and the captured insight.

The method S100 also includes, in response to the similarity score exceeding a similarity threshold and in response to the contradiction score falling below a contradiction threshold: confirming correspondence between the captured insight and the stored insight; and storing the transcript of the guided conversation and a summary of the captured insight as a new version of the stored insight at the first node.

### 1.1 Variation: Augmenting Knowledge Graph Based on Insight Dissimilarities

In one variation, the method S100 includes, in response to the similarity score falling below the similarity threshold and in response to the contradiction score falling below the contradiction threshold: detecting a dissimilarity between the captured insight and the stored insight; and augmenting the knowledge graph based on the captured insight. The method S100 further includes: based on content of the captured insight, characterizing the captured insight as specific or general relative to the stored insight; based on a word-count of the summary of the captured insight, characterizing the captured insight as high-signal or low-signal relative to the stored insight; in response to characterizing the captured insight as high-signal and characterizing the captured insight as specific, inserting an interstitial child node of the first node into the knowledge graph, the interstitial child node containing the captured insight; in response to characterizing the captured insight as high-signal and characterizing the captured insight as general, inserting an interstitial parent node of the first node into the knowledge graph, the interstitial parent node containing the captured insight; in response to characterizing the captured insight as low-signal and specific, storing the captured insight in the first node as a secondary insight; or, in response to characterizing the captured insight as high-signal and general, storing the captured insight in the first node as a primary insight. The method S100 also includes: in response to characterizing the captured insight as high-signal and in response to the similarity score falling within an intermediate similarity range below the threshold similarity, redistributing content associated with the captured insight and the stored insight between the first node and the interstitial parent node and the interstitial child node.

### 1.2 Variation: Discarding Captured Insight Based on Insight Contradictions

In one variation, the method S100 includes: in response to the contradiction score exceeding the contradiction threshold and in response to the similarity score falling below the threshold similarity, detecting contradiction and dissimilarity between the captured insight and the stored insight; inferring that the guided conversation is irrelevant to the topic of the first node; and discarding the captured insight.

### 1.3 Variation: Updating the Node Based on Insight Contradictions

In one variation, the method S100 includes: in response to the contradiction score exceeding the contradiction threshold and in response to the similarity score exceeding the similarity threshold, detecting contradiction between the captured insight and the stored insight linked to the first node; serving the captured insight and the stored insight to an expert user; prompting the expert user to select a true insight between the captured insight and the stored insight; and, in response to accessing a confirmation that the captured insight is true, updating the first node by replacing the stored insight with the captured insight; or, in response to accessing a confirmation that the stored insight is true, discarding the captured insight.

### 1.4 Variation: Mastery Tracking

In one variation, the method S100 includes: tracking a time duration from a completion of the first node by the first user; accessing a mastery decay model configured to predict mastery of insights, the mastery inversely proportional to the time duration; based on the mastery decay model and the time duration, predicting a mastery score of the first user for the first node; and, in response to the mastery score falling below a mastery threshold, assigning the first node to the first user.

### 2. Applications

Generally, the method S100 can be executed by a computer system: to deploy concepts and related insights, stored in nodes within a knowledge graph representing organizational knowledge, to users in an organization; to collect information shared between users discussing concepts in their assigned nodes; and to characterize similarities and differences between such information and corresponding insights stored in these nodes. Based on these similarities and differences, the computer system can then: detect capture of new insights (e.g., knowledge) and add the new insights to corresponding nodes; detect capture of new insights and augment the knowledge graph by inserting interstitial parent or child nodes, containing the new insights, into the graph; detect capture of new insights irrelevant to the topic of the corresponding nodes and discard the irrelevant insights; detect capture of new insights contradicting the insights already stored in the nodes of the graph, identify the correct insights among the contradicting insights, and replace the contradicting insights with the correct insights within corresponding nodes. In addition, the computer system can: confirm and record mastery of insights stored in these nodes by individual users within the organization; detect lack or loss of mastery of insights stored in these nodes by individual users within the organization; and, in response to detecting the lack or loss of mastery of particular insights, serve these insights to the users repeatedly to reinforce knowledge and understanding of these insights.

In one implementation, the computer system can: assign a first learning path, including a set of connected nodes in the knowledge graph, to a first user; assign a second learning path to a second user, wherein the second learning path and the first learning path include a first node in the knowledge graph; and assign the first user and the second user to the first node. For example, the computer system can select, as the second user, a peer of the first user with a similar position, skill level, or seniority in the organization. Therefore, the computer system can enable the first user to learn about the topic associated with the first node, review the topic, and/or share knowledge on the topic through peer-to-peer discussion with the second user or through another mode of learning such as a project-based group activity. In another example, the computer system can select, as the second user, an expert on the topic specified in the first node. Therefore, the computer system can enable the first user to learn about the topic by discussing the topic with the expert on the topic. Additionally, or alternatively, the computer system can assign a single first user to the first node and serve the first user educational content linked to the topic of the first node. Therefore, the computer system can enable the first user to learn about the topic by interacting with the educational content, which can include recorded video roleplay, multimedia content, and/or individual project-based activity.

The computer system can then: access or generate a transcription of a conversation between the first user and the second user discussing concepts linked to the first node; and, based on the transcription, extract a captured insight-such as an idea, a concept, a series of facts, a strategy for solving a problem, or an approach to performing a task—from the conversation. The computer system can then categorize the captured insight and selectively store it in one or more nodes in the knowledge graph.

In one implementation, the computer system can identify that the captured insight is analogous to or aligns with a stored insight contained in the first node, indicating that there is a significant overlap between content (e.g., knowledge, ideas, concepts, facts, etc.) of the captured insight and the stored insight. For example, the computer system can identify that the captured insight is analogous to the stored insight when knowledge shared by the first user and the second user during the conversation overlaps with the knowledge shared by other users during previous conversations on the topic associated with the first node. More specifically, the computer system can: calculate a similarity score and a contradiction score for the stored insight and the captured insight; and, in response to the similarity score exceeding a similarity threshold and the contradiction score falling below a contradiction threshold, identify that the captured insight and the stored insight are analogous. In response to identifying that the captured insight is analogous to the stored insight, the computer system can: populate the first node with the transcript of the conversation and/or a recording of the conversation; or update a summary of the stored insight stored in the first node. At a subsequent time, the computer system can serve the transcript of the conversation, the recording of the conversation, and/or the summary of the stored insight to a pair of users assigned to the node to teach or enable the pair of users to review the stored insight of the first node. Therefore, if the newly-generated insight matches (i.e., aligns with or is analogous to) the stored insight, the computer system can: collect multiple different records-such as conversation transcripts, recordings, summaries, or other educational materials derived from the conversation associated with the insight—of the stored insight and store them in the first node, thereby populating the first node with multiple versions of the stored insight. Thus, the computer system can enable users to access different versions of the same information, some of which may better align with learning styles of the users.

In another implementation, the computer system can detect that the captured insight differs from the stored insight, such as when ideas or concepts shared by the first user and the second user during the conversation do not overlap with knowledge shared by other users during previous conversations on the same topic. For example, the computer system can detect that the captured insight differs from the stored insight in response to the semantic similarity falling below the similarity threshold and the contradiction score falling below the contradiction threshold.

In one implementation, in response to identifying that the captured insight differs from the stored insight and in response to characterizing the captured insight as low-signal-indicating that the amount of knowledge (e.g., ideas, concepts, facts, etc.) represented by the captured insight can be communicated in a relatively short (e.g., 10 minutes) amount of time—the computer system can: store the captured insight in the first node as a separate insight from the stored insight; and populate the first node with the conversation transcript, recording, summary, or other educational materials derived from the conversation associated with the insight. Therefore, the computer system can: group related insights in a single node in the knowledge graph; serve a group of related insights associated with the single node to a pair of users; and prompt the pair of users to discuss a topic that represents the group of related insights.

In another implementation, in response to identifying that the captured insight differs from the stored insight and in response to characterizing the captured insight as high-signal—indicating that the amount of knowledge (e.g., ideas, concepts, facts, etc.) represented by the captured insight can be communicated in a relatively long (e.g., more than 20 minutes) amount of time, the computer system can further characterize the captured insight as either specific—indicating that the stored insight is a pre-requisite for learning or understanding the captured insight—or general—indicating that the captured insight is a pre-requisite for learning or understanding the stored insight. In response to characterizing the captured insight as specific, the computer system can insert an interstitial child node of the first node into the knowledge graph. And, in response to characterizing the captured insight as general, the computer system can insert an interstitial parent node of the first node into the knowledge graph. Furthermore, if the computer system detects an overlap between the captured insight and the stored insight, such as detecting that the similarity score falls within a range below the similarity threshold, the computer system can redistribute information or knowledge represented by the captured insight and the stored insight between the first node and the inserted interstitial node.

Therefore, in response to identifying that the captured insight differs from the stored insight, the computer system can: automatically augment the knowledge graph to include the captured insight in the knowledge graph; add a parent or a child interstitial node populated with the captured insight to the knowledge graph according to the characterization of the captured insight; and redistribute knowledge or information between two or more nodes in the knowledge graph to improve the grouping of knowledge or information within the nodes and improve the alignment of knowledge or information with the topics of the nodes. Thus, the computer system can sequentially assign to a user a series of nodes on a related topic and with increasing specificity, enabling the user to progress from learning lower-level (e.g., fundamental, generic) information or knowledge to learning higher-level (e.g., specific, deep) information or knowledge.

In another implementation, the computer system can identify that the captured insight contradicts the stored insight, such as when knowledge shared by the first user and the second user during the conversation is mutually exclusive with knowledge shared by other users during previous conversations on the topic. More specifically, the computer system can identify that the captured insight contradicts the stored insight in response to the contradiction score exceeding the contradiction threshold and in response to the similarity score exceeding the similarity threshold. In one example, in response to identifying that the captured insight contradicts the stored insight—which can indicate that that either the captured insight or the stored insight is outdated or incorrect—the computer system can: serve the captured insight and the stored insight to a third user, such as a knowledge graph operator or an expert user; and prompt the third user to select a true insight between the captured insight and the stored insight. Additionally, or alternatively, the computer system can access external information sources to determine whether the captured insight or the stored insight is true. Then, in response to accessing a confirmation that the captured insight is true, the computer system can update the first node by replacing the stored insight with the captured insight; inform users who generated the stored insight that the stored insight has been replaced with the captured insight; and teach these users knowledge or information represented by the captured insight. In response to accessing a confirmation that the stored insight is true, the computer system can: discard the captured insight; and teach the first user and the second user knowledge or information represented by the stored insight. Therefore, the computer system can: identify mutually exclusive or conflicting information or knowledge shared by users in the organization; identify the correct information; inform a manager or a leader of the organization of the presence of contradicting or outdated information in the organization—which can indicate that users in the organization require improved supervision or training; and dynamically update the nodes in the knowledge graph to discard outdated insights and include new, correct insights based on the conversations between users. Thus, the computer system can maintain and augment the knowledge graph with minimum input from a human.

In one implementation, the computer system can identify that the captured insight is irrelevant to the topic of the first node indicating that the first user and the second user have not discussed the topic. For example, in response to the contradiction score exceeding the contradiction threshold and in response to the similarity score falling below the similarity threshold, the computer system can: identify that the captured insight is irrelevant to the topic; discard the captured insight and the conversation transcript, recording, and summary; and flag the first user and the second user (e.g., to forgo pairing the first user and the second user in the future or to investigate the skill level of the first user and the second user). Therefore, the computer system can automatically detect information irrelevant to the topic of a node and discard this information.

In another implementation, the computer system can selectively re-deploy certain nodes in the knowledge graph to the first user. In one example, the computer system can re-deploy the first node to the first user after a threshold time duration from the completion of the first node by the first user in order to enable the first user to review the insights contained in the first node. In another example, the computer system can re-deploy the first node to the first user in response to the stored insight of the first node being replaced with a new captured insight in order to inform the user that the stored insight is outdated and teach the first user the new captured insight. Therefore, the computer system can selectively re-deploy a node in the knowledge graph to a user to enable the user to: review stored insights linked to the node; learn newly-captured insights associated with the node; and/or be notified that that stored insights previously linked to the node have been replaced. Thus, the computer system can enable the users in the organization to maintain their knowledge and skills and to continuously learn new insights generated within the organization.

### 2.1 Glossary and Terms

Generally, “node,” as used herein, represents a container for a set of insights linked to a topic. A node can also include: a discussion prompt configured to initiate a guided conversation about the topic; and a set of educational materials, such as videos and transcripts of guided conversations prompted by the discussion prompt and/or articles and learning modules related to the topic specified in the node.

“Insight,” as used herein, represents a unit of knowledge, such as a concept, an idea, a procedure, or a set of facts, related to a topic.

“Learning path,” as used herein, refers to a set of connected nodes in the knowledge graph. The computer system can deploy the learning path to a user to teach the user about a set of topics represented by the nodes in the learning path. Deploying the learning path to the user involves assigning each node in the learning path sequentially to the user.

“Starting node,” as used herein, represents a node in the learning path that is an ancestor node to every other node in the learning path and contains pre-requisite concepts for every other node in the learning path.

“Destination node,” as used herein, represents a node in the learning path, which is a descendant node to every other node in the learning path.

“Interstitial node,” as used herein, represents a node inserted between a pair of nodes.

### 3. Knowledge Graph

As shown in FIG. 1, a knowledge graph includes a tree of nodes connected by edges, with each node in the knowledge graph representing a set of insights associated with a particular topic and each edge in the knowledge graph representing a parent-child relationship between a pair of nodes. A parent node in the pair of nodes includes a node that generated the child node in the pair of nodes. Therefore, the parent node contains a first set of concepts pre-requisite to the second set of concepts contained in the child node. In one example, a knowledge graph for an organization, such as a retail corporation operating a chain of department stores, can include a first node linked to the topic, “best practices for supporting in-store electronics sales,” and containing a set of insights including “understanding technical specifications of products and how they translate into benefits for different customer needs,” “creating hands-on demo areas where customers can test and interact with products,” “offering one-on-one consultations to customers to provide tailored shopping advice.”

As discussed in U.S. Provisional Application 63/468,874, the computer system can generate the knowledge graph by: initiating a first guided conversation, such as a video conference, between a pair of users in an organization by serving a discussion prompt linked to a discussion topic to the pair of users; recording an audio file of the guided conversation and generating a transcription of the first audio file; based on the transcription, extracting a first insight discussed in the guided conversation, the first insight representing a unit of knowledge communicated by the pair of users during the guided conversation; based on a proximity of language concepts of the first insight and the discussion prompt exceeding a proximity threshold, generating a first node associated with the discussion topic and populating the first node with the first insight.

The computer system can also: based on the transcription, extract a second insight discussed in the guided conversation; based on proximity of language concepts of the second insight and the discussion prompt falling below the proximity threshold, generate a proposed second node, which is a child node of the first node; and populate the second node with the second insight. The computer system can also: generate a request to confirm the proposed second node in the graph of nodes; serve the request to a third user, such as a knowledge graph manager; and, in response to the third user confirming the proposed second node, insert the proposed second node into the knowledge graph.

### 4. Database of User Profiles

The computer system can access and update an electronic database of user profiles, each user profile in the electronic database containing identifying information and node completion status of a particular user in an organization. More specifically, a user profile in the electronic database can contain: a name or other identifying information of the user; a position (e.g., job title, role, rank) of the user in the organization, such as “location manager” and “sales associate;” a skill level of the user, such as “expert” or “novice;” and a list of nodes that the user has completed and corresponding timestamps of completion of each node in the list.

### 5. Initial Graph Deployment

Generally, the computer system can deploy the knowledge graph to a user in an organization by identifying a learning path in the knowledge graph for the user and sequentially serving each node in the learning path to the user. For example, the computer system can deploy the learning path to a user who has not previously completed any nodes in the knowledge graph, such as a new employee in the organization or a user recently onboarded to a platform (e.g., companion application executing on a mobile device of the user) supporting the knowledge graph. In another example, the computer system can deploy the learning path to a user who has previously completed one or more nodes in the knowledge graph. Generally, the computer system can deploy the knowledge graph to the user via the learning path to teach or expose the user to a set of insights represented in the learning path.

### 5.1 Identifying the Learning Path

The computer system can initiate deployment of the knowledge graph to a first user by identifying a learning path for the first user, the learning path representing a set of connected nodes served to the first user in sequence (e.g., one after another) to teach or expose the first user to a set of topics represented in the learning path. For example, the computer system can select a learning path including a set of nodes containing a set of topics linked to “customer support best practices.”

More specifically, the computer system can select a destination node for the learning path, the destination node including a node in the knowledge graph that the first user has not completed within a threshold time period preceding the current time (i.e., recently completed). Furthermore, the computer system can select a destination node succeeding a set of nodes (e.g., 10 nodes) that the first user has not completed within the threshold time period.

The computer system can also select a starting node for the learning path, the starting node representing a node that the first user can complete prior to completing other nodes in the learning path. Furthermore, the starting node (hereinafter referred as the “first node”) can include a node that: precedes the destination node in the learning path; is an ancestor node of the destination node; and/or contains pre-requisite insights for every other node in the learning path. The computer system can then identify the learning path in the knowledge graph, the learning path including the first node, the destination node, and a set of nodes interposed between the first node and the destination node in the knowledge graph.

In one example, the computer system can select the learning path for the first user based on the position of the first user in the organization. More specifically, the computer system can: identify the position (e.g., job title, rank) of the first user in the organization; and, based on the position, select a destination node of the learning path in the knowledge graph, the destination node representing a node linked to a topic relevant to the first user based on the user's position. For example, the computer system can: identify the status of the first user as a “customer support specialist;” and select a destination node containing a topic, “customer support chat etiquette.”

In one example, the computer system can prompt the first user to select a destination node for the learning path. More specifically, the computer system can select a set of possible destination nodes in the knowledge graph based on the position and the skill level of the first user, each possible destination node linked to a topic related to the position of the first user. Then, the computer system can serve the set of possible destination nodes to the first user and prompt the first user to select one destination node from the set of destination nodes. For example, the first user may then select from the set of destination nodes, a destination node linked to a topic that the first user is most interested in discussing. For example, the computer system can: identify the status of the first user as “location general manager;” and select the set of possible destination nodes linked to topics, “customer relations,” “inventory management,” and “location security.” In turn, the first user may select a designation node linked to “inventory management.”

In one implementation, the computer system can label each node in the knowledge graph with a label representing: a) user position(s) to which the node may be relevant; or b) subject to which the topic specified in the node relates. For example, the computer system can: label a first node in a knowledge graph with a first set of labels including “sales representative,” “sales manager,” and “customer support;” and label a second node in the knowledge graph with a second set of labels including: “inventory manager” and “logistics operator.” In this example, in response to detecting that a position of the first user includes “inventory manager,” the computer system can select a first learning path including the second node for the first user. In another example, the computer system can: label the first node in the knowledge graph with a third set of labels including: “sales,” “sales management,” and “customer support;” and label a second node in the knowledge graph with a second set of labels including “inventory management” and “transportation logistics.” In this example, in response to detecting that a position of a first user includes “inventory manager,” the computer system can prompt the first user to select a destination node among a set of nodes including a second node.

In one example, the computer system can serve a graphical representation of the knowledge graph to the first user and prompt the first user to select a leaf node in the knowledge graph as a destination node for a learning path. In this implementation, the first user may select a destination node representing a topic that the first user is interested in learning.

### 5.2 Serving a First Node to the First User

After selecting the learning path for the first user, the computer system can serve content of the first node in the learning path to the first user. More specifically, the computer system can: initiate a guided conversation, such as a video conference or a phone call, between the first user and a second user; prompt the first user and the second user to discuss a topic linked to the first node; and generate a transcript of the guided conversation. For example, for the first node linked to the topic, “increasing in-store electronic product sales,” the computer system can prompt the first user and the second user to “discuss three strategies for increasing in-store electronic product sales.”

In one example, the computer system can select, as the second user, a user whose learning path overlaps with the learning path of the first user at the first node. Furthermore, the computer system can select, as the second user, a peer of the first user, such as a user with similar position, skill level, or seniority. Similarly, the computer system can: select a group of users whose learning paths overlap with the learning path of the first user at the first node; and initiate a group conversation between the first user and the group of users. Therefore, the computer system can facilitate learning on the topic associated with the first node through peer-to-peer or group discussion.

In another example, the computer system can select, as the second user, an expert user who can teach insights related to the topic to the first user. For example, the computer system can select the expert user who: previously completed the first node; generated the insights contained in the first node; and/or is a domain expert on the topic associated with the first node in the organization. Therefore, the computer system can facilitate teaching of insights associated with the first node to the first user by the second user.

In yet another example, the computer system can withhold selecting the second user for the guided conversation and prompt the first user to discuss, verbally or in writing, the topic linked to the first node. Therefore, the computer system can: test knowledge of the first user on the topic, extract knowledge of the first user on the topic, or prompt the first user to review the topic. For example, the computer system can thereby test the first users' mastery of the topic or a subject associated with the learning path to identify the skill level of the first user, such as “expert” or “novice.”

### 5.3 Identifying Captured Insight of the First Node

The computer system can then: access the transcript of the guided conversation; and, based on the transcript, extract a captured insight discussed by the first user and the second user in the guided conversation.

More specifically, the computer system can extract the captured insight based on the transcript by: identifying language concepts of the transcript via topic modeling techniques; characterizing an emotional tone of the language concepts via sentiment analysis techniques; identifying entities in the transcript, the entities representing real-world objects such as people, places, organizations, dates, and numbers; categorizing relationships between entities and the language concepts (e.g., “is a type of,” “located in”); accessing external information (e.g., definitions, related concepts, synonyms, ontologies) of the language concepts and entities to contextualize the language concepts and the entities within the transcript; and, based on the external information, language concepts, and entities, generating a summary of the captured insight.

### 5.4 Characterizing Relation and Updating the Node

The computer system can then: access a stored insight contained in the node and extracted from a preceding guided conversation between another pair of users; characterize a relationship between the stored insight and the captured insight; and, based on the relationship, identify whether the captured insight is 1) analogous to the stored insight, 2) different from the stored insight, or 3) conflicts with the stored insight.

More specifically, the computer system can characterize the relationship between the stored insight and the captured insight by: accessing the transcript (or summary) of the guided conversation and a stored transcript that generated the stored insight; identifying a first language concept of the transcript and a second language concept of the stored transcript; and calculating a similarity score for the first language concept and the second language concept (also rereferred to as “a pair of language concepts”); calculating a contradiction score between the pair of language concepts; and, based on the similarity score and the contradiction score, characterizing the relationship between the stored insight and the captured insight.

More specifically, the computer system can: generate a set of vectors (i.e., word embeddings) that represent the pair of language concepts in a multi-dimensional space, where the distance and direction between vectors indicates semantic similarity; and calculate similarity scores between the pair of language concepts via cosine similarity or other techniques. In addition, the computer system can identify context of the pair of language concepts by: identifying references (e.g., coreferences) of the pair of language concepts in the transcript and the stored transcript; accessing external information relating to the pair of language concepts; and compiling the references and the external information to generate the context of the pair of language concepts. Furthermore, the computer system can detect contradictions between the pair of language concepts by: identifying linguistic markers of negation in the context of the pair of language concepts; inferring contradiction between the pair of language concepts in response to detecting that the language concepts exhibit mutually exclusive properties or imply mutually exclusive outcomes; and, based on the linguistic markers of negation and inferred contradiction, calculating the contradiction score for the pair of language concepts.

In this manner, the computer system can: calculate a set of similarity scores for each pair of language concepts identified in the transcript and the stored transcript, respectively; and, based on the set of similarity scores, calculate a cumulative similarity score characterizing semantic similarity between the captured insight and the stored insight. Similarly, the computer system can calculate a set of contradiction scores for each pair of language concepts identified in the transcript and the stored transcript, respectively; and, based on the set of contradiction scores, calculate a cumulative contradiction score characterizing a degree of contradiction between the captured insight and the stored insight. Then, based on the cumulative similarity score and the cumulative contradiction score, the computer system can characterize the relationship between the stored insight and the captured insight.

### 5.4.1 Captured Insight and Stored Insight are Analogous

In one implementation, in response to the cumulative similarity score exceeding a similarity threshold and the cumulative contradiction score falling below a contradiction threshold, the computer system can: detect that the captured insight corresponds to the stored insight indicating that the captured insight and the stored insight are analogous. For example, the computer system can detect that the captured insight and the stored insight describe a single “approach to handling customer complaints” described with a first set of terms in the transcript and a second set of terms in the stored transcript. Then, in response to the captured insight corresponding to the stored insight, the computer system can augment (e.g., update) the first node by storing the transcript of the guided conversation, the summary of the captured insight, and/or other educational materials generated based on the guided conversation to the first node. Therefore, in response to identifying that the captured insight and the stored insight are analogous, the computer system can store multiple versions of the stored insight in the first node to enable users to access different versions of the same knowledge or information.

### 5.4.2 Captured Insight and Stored Insight are Different

In response to the cumulative similarity score falling below the similarity threshold and the cumulative contradiction score falling below the contradiction threshold, the computer system can: detect that the captured insight differs from the stored insight indicating that the captured insight and the stored insight are distinct (e.g., not analogous), without contradicting one another. For example, the computer system can detect that the captured insight and the stored insight describe two different but valid approaches to handling customer complaints, such as 1) “openly communicating with customers about known issues and the steps being taken to address them” and 2) “offering solutions that address the customer's immediate concern, such as refunds and replacements.”

In response to detecting that the captured insight differs from the stored insight, the computer system can update the first node by linking the captured insight to the first node, such that the first node contains both the stored insight and the captured insight. More specifically, in response to the captured insight differing from the stored insight, the computer system can: characterize the relationship between the captured insight and the topic (e.g., based on proximity of language concepts of the captured insight and the topic specified in the first node), the relationship indicating whether the captured insight directly relates to the topic; and, in response to detecting that the captured insight is related to the topic (e.g., proximity of language concepts exceeds a threshold), updating the first node by linking the captured insight to the first node. For example, in response to verifying that the captured insight, “offering solutions that address the customer's immediate concern, such as refunds and replacements,” relates to the topic specified in the first node, “handling customer complaints,” the computer system can update the first node to include the captured insight. Furthermore, the computer system can link the transcript and the summary to the first node, as attributes of the captured insight.

In response to detecting that the captured insight differs from the stored insight, the computer system can update another node in the knowledge graph by linking the captured insight to the other node, such that the other node contains the captured insight. More specifically, in response to the captured insight differing from the stored insight, the computer system can: characterize the relationship between the captured insight and the topic specified in the first node (e.g., based on proximity of language concepts of the captured insight and the topic); in response to detecting that the captured insight is not related to the topic (e.g., the proximity of language concepts falls below the threshold), search for match between captured insight and a topic of every node in the knowledge graph; and, in response to identifying a match between the captured insight and a second topic of a second node in the knowledge graph, update the second node by linking the captured insight in the second node. For example, in response to verifying that the captured insight, “utilizing predictive analytics to anticipate customer needs and preferences,” does not directly relate to the topic specified in the first node, “handling customer complaints,” the computer system can match the captured insight to the second topic, “customer relationship management,” of the second node. Furthermore, the computer system can link the transcript and the summary to the first node, as attributes of the captured insight.

In response to detecting that the captured insight differs from the stored insight, the computer system can generate an interstitial node, such as a child of the first node or a parent node of the first node, containing the captured insight. More specifically, in response to the captured insight differing from the stored insight, the computer system can: characterize the relationship between the captured insight and the topic specified in the first node (e.g., based on proximity of language concepts of the captured insight and the topic); in response to detecting that the captured insight is not related to the topic associated with the first node (e.g., the proximity of language concepts falls below the threshold), search for a match between captured insight and a topic of every node in the knowledge graph; and, in response to failing to identify a match between the captured insight and the topic of every node in the knowledge graph, generate a new topic for the captured insight and generate an interstitial node containing the captured insight and the new topic. For example, in response to verifying that the captured insight, “utilizing predictive analytics to anticipate customer needs and preferences,” does not directly relate to the topic specified in the first node, “handling customer complaints,” and does not match any other topic in the knowledge graph, the computer system can: generate a new topic, “customer analytics system,” for the captured insight; and generate the interstitial node containing the captured insight and the new topic.

In one implementation, in response to the cumulative similarity score falling below the similarity threshold and, in response to the cumulative contradiction score falling below the contradiction threshold, the computer system can: characterize the captured insight as specific or general relative to the stored insight based on content of the captured insight; and characterize the captured insight as high-signal (e.g., high word-count) or low-signal (e.g., low word-count) relative to the stored insight based on a word-count (i.e., length) of the summary of the captured insight. For example, the computer system can characterize the captured insight as low-signal, indicating that the amount of knowledge (e.g., ideas, concepts, facts, etc.) represented by the captured insight can be communicated in a first (e.g., 10 minutes) time duration. In another example, the computer system can characterize the captured insight as high-signal indicating that the amount of knowledge (e.g., ideas, concepts, facts, etc.) represented by the captured insight can be communicated in a second (e.g., more than 20 minutes) time duration, exceeding the first time duration.

In this implementation, in response to characterizing the captured insight as low-signal, the computer system can store the captured insight in the first node as a separate insight from the stored insight; and populate the first node with the conversation transcript, recording, summary, or other educational materials derived from the conversation associated with the insight. Therefore, the computer system can group related, low-signal insights in a single node in the knowledge graph.

Additionally, or alternatively, in response to characterizing the captured insight as high-signal, the computer system can characterize the captured insight as: specifically indicating that the stored insight is a pre-requisite for learning or understanding the captured insight; or generally indicating that the captured insight is a pre-requisite for learning or understanding the stored insight. In response to characterizing the captured insight as specific, the computer system can insert the interstitial child node of the first node into the knowledge graph. Or, in response to characterizing the captured insight as general, the computer system can insert an interstitial parent node of the first node into the knowledge graph. Furthermore, in response to detecting that the cumulative similarity score falls within a range below the similarity threshold, the computer system can redistribute information or knowledge represented by the captured insight and the stored insight between the first node and the interstitial child node or the interstitial parent node.

Therefore, in response to identifying that the captured insight differs from the stored insight, the computer system can: automatically augment the knowledge graph to include the captured insight in the knowledge graph; add a parent or a child interstitial node, populated with the captured insight, to the knowledge graph according to the characterization of the captured insight; and redistribute knowledge or informatization between two or more nodes in the knowledge graph to improve the grouping of the knowledge or information within the nodes and to improve alignment of the knowledge or information with the topics of the nodes.

### 5.4.3 Captured Insight and Stored Insight are Contradicting

In one implementation, in response to the cumulative contradiction score exceeding a contradiction threshold and the cumulative similarity score exceeding the similarity threshold, the computer system can: detect that the captured insight contradicts the stored insight indicating that the captured insight and the stored insight are mutually exclusive. For example, the computer system can detect that the captured insight and the stored insight represent contradicting approaches to handling customer complaints, such as 1) “adhering to policies: setting clear boundaries for what is possible to resolve a customer complaint” and 2) “customer is always right: doing everything possible to resolve a customer complaint.”

In response to the detecting that the captured insight contradicts the stored insight, the computer system can either: update the first node by replacing the stored insight with the captured insight; or discard the captured insight. In one example, in response to detecting that the captured insight contradicts the stored insight, the computer system can: serve the stored insight to a user, such as a knowledge graph manager, a user who generated the stored insight, or an expert user on the topic linked to the first node; prompt the user to confirm that the stored insight is outdated; and, in response to accessing a confirmation that the stored insight is outdated, update the first node by replacing the stored insight with the captured insight. In another example, in response to detecting that the captured insight contradicts the stored insight, the computer system can: serve the captured insight and the stored insight to a user, such as a knowledge graph manager or an expert user on the topic linked to the first node; prompt the user to select the correct insight; and, in response to receiving a selection of the stored insight as the correct insight, discard the captured insight.

### 5.4.4 Captured Insight is Irrelevant

In one implementation, the computer system can: detect both contradiction and dissimilarity of the captured insight and the stored insight in response to the cumulative contradiction score exceeding the contradiction threshold and in response to the cumulative similarity score falling below the threshold similarity; infer that the captured insight and the guided conversation are irrelevant to the topic of the first node; and discard the captured insight. Furthermore, the computer system can flag the first user and the second user for investigation of the skill level of the first user and the second user or forgo pairing the first user and the second user in the future. Therefore, the computer system can automatically detect insights irrelevant to the topic, which can be indicative of incompatibility of the first user and the second user or low skill level of the first user and the second user.

### 5.5 Recording User Progress

After serving the first node to the first user, the computer system can: record a completion of the first node by the first user and the corresponding timestamp of completion in the electronic profile of the first user in the electronic database. Additionally, or alternatively, the computer system can link the electronic profile of the first user and the corresponding timestamp to the first node in order to record completion of the first node by the first user. Therefore, the computer system can maintain a record of node completion of the first user and track the progress of the user though the learning path.

### 5.6 Deploying Each Node in the Learning Path

Succeeding the completion of the first node by the first user, the computer system can: identify a second node succeeding the first node in the learning path, the first node representing a pre-requisite for the second node; and serve content of the second node to the first user. The computer system can repeat this process for every node in the learning path. The computer system can thus sequentially deploy each node in the learning path to the first user to teach the first user a series of insights contained in each node of the learning path.

### 6. Secondary Graph Deployment

Generally, the computer system can re-deploy the first node to the first user after the initial (e.g., first time) deployment to: enable the first user to review the insights (e.g., the stored insight, the captured insight) contained in the first node; and/or to learn new insights, generated by other users, that have been linked to the first node after the first user completed the first node. Similarly, the computer system can: deploy a newly-generated interstitial node to the first user, who has completed a parent node and a child node of the newly-generated interstitial node, to enable the first user to learn a new insight linked to the newly-generated interstitial node.

### 6.1 Example: Contradiction-Based Node Redeployment

In one implementation, in response to replacing the stored insight with the captured insight in the first node, the computer system can: identify a group of users who have completed the first node; and schedule re-deployment of the first node to each user in the group of users. Thus, the computer system can re-deploy the first node to the group of users who have previously completed the node to enable the group of users to learn the captured insight, which is the updated or correct insight. Additionally, or alternatively, in response to replacing the stored insight with the captured insight in the first node, the computer system can: generate a notification indicating that the insight associated with the first node has been replaced; and serve the notification to the group of users.

### 6.2 Example: Mastery Decay-Based Node Redeployment

In one example, the computer system can re-deploy the first node to the first user in response to predicting that the first user's mastery of the concepts associated with the first node has declined below a threshold level. More specifically, the computer system can: identify a time duration from the completion of the first node to the current time (e.g., six months); access a mastery decay model; based on the time duration and the mastery decay model, predict a mastery score of the user for the first node, the mastery score inversely correlated with the time duration (e.g., the longer the time duration the lower the mastery score); and, in response to the mastery score falling below a mastery threshold, re-deploy the first node to the first user.

Generally, the computer system can derive the mastery decay model for the first node and the first user, the mastery decay model relating the mastery score of the first user to the time duration from completion of the first node to current time. More specifically, the computer system can derive the mastery decay model based on a quantality (e.g., number) of node updates of the first node occurring over the time duration; a type (e.g., insight replacement, addition of new versions of the stored insight) of node updates; a position of the node in the knowledge graph; a skill level of the first user; and/or a position of the first user in the organization. For example, the computer system can decrease a negative slope of the mastery decay model in response to detecting an increase in the quantity of updates of the node. In another example, the computer system can: decrease the negative slope of the mastery decay model by a first difference (e.g., difference in mastery score decrease per unit of time) in response to an update to the first node including an addition of a new version of the stored insight to the node; and decrease the negative slope by a second difference, greater than the first deference, in response to the update to the first node including a replacement of the stored insight with the captured insight.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a position of a first user in an organization;
based on the position, identifying a learning path in a knowledge graph for the first user, the learning path comprising a set of connected nodes within the knowledge graph;
retrieving a topic linked to the first node in the learning path;
prompting the first user and a second user to discuss the topic during a guided conversation;
generating a transcript of the guided conversation;
based on the transcript, extracting a captured insight discussed by the first user and the second user during the guided conversation;
accessing a stored insight linked to the first node;
calculating a similarity score between the stored insight and the captured insight; calculating a contradiction score between the stored insight and the captured insight;
in response to the similarity score exceeding a similarity threshold and in response to the contradiction score falling below a contradiction threshold:
confirming correspondence between the captured insight and the stored insight; and
storing the transcript of the guided conversation and a summary of the captured insight as a new version of the stored insight at the first node.
